(19) United States
(12) Patent Application Publication
(10) Pub. No.: US 2011/0309993 A1
(43) Pub. Date: Dec. 22, 2011

(54) SMALL-SIZE PRINTED CIRCUIT BOARD-PRINTED MEANDER LINE INVERTED-F ANTENNA FOR RADIO FREQUENCY INTEGRATED CIRCUITS

(76) Inventors: ZIMING HE, IRVINE, CA (US); PING PENG, IRVINE, CA (US); OLEKSANDR GORBACHOV, IRVINE, CA (US)

(21) Appl. No.: 13/164,467

(22) Filed: Jun. 20, 2011

Related U.S. Application Data
(60) Provisional application No. 61/357,010, filed on Jun. 21, 2010.

(51) Int. Cl. H01Q 1/50; H01Q 1/38

(52) U.S. Cl. 343/860; 343/700 MS

(57) ABSTRACT

A printed circuit board-printed antenna for a radio frequency front end with an antenna port for a predefined operating frequency band is disclosed. A ground line and a feed line are connected to a radiating element fixed to a bare section of a printed circuit board substrate. The radiating element is in an inverted-F configuration with a primary segment extending in a perpendicular relationship to the connected ground line and the feed line. A plurality of successive meander segments is initially connected to the primary segment and ends at a radiating element tip. A high frequency current loop is formed with an origin from the feed line to a terminus via the ground line and the radiating element tip. The high frequency current loop confines current and electronic fields on the radiating element.

### CROSS-REFERENCE TO RELATED APPLICATIONS

This application relates to and claims the benefit of U.S. Provisional Application No. 61/357,010 filed Jun. 21, 2010 and entitled “COMPACT HIGH PERFORMANCE PCB-PRINTED ANTENNA FOR RF FRONT-END IC APPLICATIONS,” which is wholly incorporated by reference herein.

### STATEMENT RE: FEDERALLY SPONSORED RESEARCH/DEVELOPMENT

Not Applicable

### BACKGROUND

1. Technical Field

The present disclosure relates generally to radio frequency (RF) communications and antennas, and more particularly to printed circuit board-printed meander line inverted-F antennas (IFAs) for use with RF integrated circuits in industrial-scientific-medical (ISM) band wireless networking.

2. Related Art

Wireless communications systems find application in numerous contexts involving information transfer over long and short distances alike, and there exists a wide range of modalities suited to meet the particular needs of each. These systems include cellular telephones and two-way radios for distant voice communications, as well as shorter-range data networks for computer systems employing technologies such as the Wireless Local Area Network (WLAN), Bluetooth, and Zigbee, among many others. Generally, wireless communications involve a radio frequency (RF) carrier signal that is variously modulated to represent data, and the modulation, transmission, receipt, and demodulation of the signal conform to a set of standards for coordination of the same.

One fundamental component of any wireless communications system is the transceiver, i.e., the transmitter circuitry and the receiver circuitry. The transceiver encodes information (whether it be digital or analog) to a baseband signal and modules the baseband signal with an RF carrier signal. Upon receipt, the transceiver down-converts the RF signal, demodulates the baseband signal, and decodes the information represented by the baseband signal. The transceiver itself typically does not generate sufficient power or have sufficient sensitivity for reliable communications. The wireless communication system therefore includes a front end module (FEM) with a power amplifier for boosting the transmitted signal, and a low noise amplifier for increasing reception sensitivity.

Another fundamental component of a wireless communications system is the antenna, which is a device that allow for the transfer of the generated RF signal from the transmitter/front end module to electromagnetic waves that propagate through space. The receiving antenna, in turn, performs the reciprocal process of turning the electromagnetic waves into an electrical signal or voltage at its terminals that is to be processed by the receiver/front end module. Oftentimes the transceiver, the front end circuit, and the antenna are incorporated on to a single printed circuit board for reducing the overall footprint of the communications system, and for reducing production costs.

Optimal performance of a communications system is dependent upon the configuration of both the antenna and the front end circuit. It is desirable for the antenna to have a high gain as well as a wide bandwidth. There must also be an adequately low return loss, ideally better than −15 dB, so that satisfactory performance of the transceiver and the front end module are maintained even when the operating point has drifted beyond a normal range. More particularly, the output matching circuit for the power amplifier and the input matching circuit for the low noise amplifier are both tuned to a standard impedance of 50 Ohm. If the return loss (S11) of the antenna is minimized to the aforementioned −15 dB level, performance degradation of the power amplifier remains negligible. As the various electrical components of communications devices are densely packed, interference between the antenna and such nearby components is also a source of performance degradation. With current antenna designs, the return loss (S11) at the edges of the operating frequency band is typically around −5 dB, leading to a reduced performance of the front end module. This, in turn, reduces the total radiated power, the total integrated sensitivity of the transceiver, and the quality of the digital signal. The cumulative effects of such performance degradations include shorter communication link distances, increased data transfer times, and a host of other problems attendant thereto.

Accordingly, there is a need in the art for printed circuit board-printed meander line antennas that have excellent return loss, wide bandwidth, high gain, and high efficiency.

### BRIEF SUMMARY

In accordance with one embodiment of the present disclosure, a printed circuit board (PCB)-printed antenna for a radio frequency (RF) front end integrated circuit is contemplated. The RF front end integrated circuit has an antenna port as well as a predefined operating frequency band. The printed antenna may include a printed circuit board substrate having a conductive ground plane and a bare section. Additionally, there may be a ground line connected to the conductive ground plane. The ground line may define a ground port. The printed antenna may also include a feed line that defines a feed port connectible to the antenna port of the RF front end integrated circuit. There may also be an electrically conductive radiating element that is fixed to the bare section of the printed circuit board substrate. The radiating element may be in an inverted-F configuration with a primary segment thereof extending in a perpendicular relationship to the connected ground line and the feed line. Furthermore, the radiating element may include a plurality of successive meander segments that is initially connected to the primary segment and ends at a radiating element tip. A high frequency current loop may be formed with an origin from the feed line to a terminus of the ground plane on the printed circuit board substrate via the ground line and the radiating element tip. The high frequency current loop may confine current and electronic fields on the radiating element. The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a printed circuit board (PCB)-printed antenna assembly in accordance with an embodiment of the present disclosure;

FIG. 2 is a top plan view of a printed antenna showing a radiating element, a feed line, and a ground line;

FIG. 3 is a top plan view of the PCB-printed antenna assembly showing a high frequency current loop formed between the printed antenna and a PCB substrate during operation;

FIG. 4 is a Smith chart illustrating a simulated return loss of the printed antenna without a matching circuit;

FIG. 5 is a schematic diagram of a first exemplary embodiment of a matching circuit connectible to the printed antenna to achieve the contemplated performance objectives;

FIG. 6 is a Smith chart illustrating the return loss of the printed antenna with and without the first embodiment of the matching circuit shown in FIG. 4;

FIG. 7 is a graph showing the return loss of the printed antenna across the 2.4-2.49 GHz operating frequency band with the first embodiment of the matching circuit shown in FIG. 4;

FIG. 8 is a schematic diagram of a second exemplary embodiment of a matching circuit connectible to the printed antenna to achieve the contemplated performance objectives;

FIG. 9 is a Smith chart illustrating a simulated return loss of the printed antenna with and without the second embodiment of the matching circuit shown in FIG. 8;

FIG. 10 is a graph showing the return loss of the printed antenna across the 2.4-2.49 GHz operating frequency band with the second embodiment of the matching circuit shown in FIG. 8;

FIG. 11 is a three-dimensional graph illustrating a simulated radiation pattern of the printed antenna;

FIG. 12 is a top plan view of the PCB-printed antenna assembly with a simulated current distribution superimposed thereon; and

FIG. 13 is a top plan view of the PCB-printed antenna assembly with a simulated electric field distribution superimposed thereon.

Common reference numerals are used throughout the drawings and the detailed description to indicate the same elements.

### DETAILED DESCRIPTION

A printed circuit board (PCB)-printed antenna having field-confined, wideband and high efficiency performance features is contemplated in accordance with various embodiments of the present disclosure. In one operating frequency band of 2400 MHz to 2483.5 MHz, the return loss is contemplated to be better than −22 dB. Furthermore, its bandwidth where the return loss (S11) is −10 dB is envisioned to be around 360 MHz. Additionally, the printed antenna has stable performance and not prone to degradation or detuning resulting from nearby components and from objects placed in its vicinity. The detailed description set forth below in connection with the appended drawings is intended as a description of the several presently contemplated embodiments of the antenna assembly, and is not intended to represent the only form in which the disclosed invention may be developed or utilized. The description sets forth the functions and structural features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

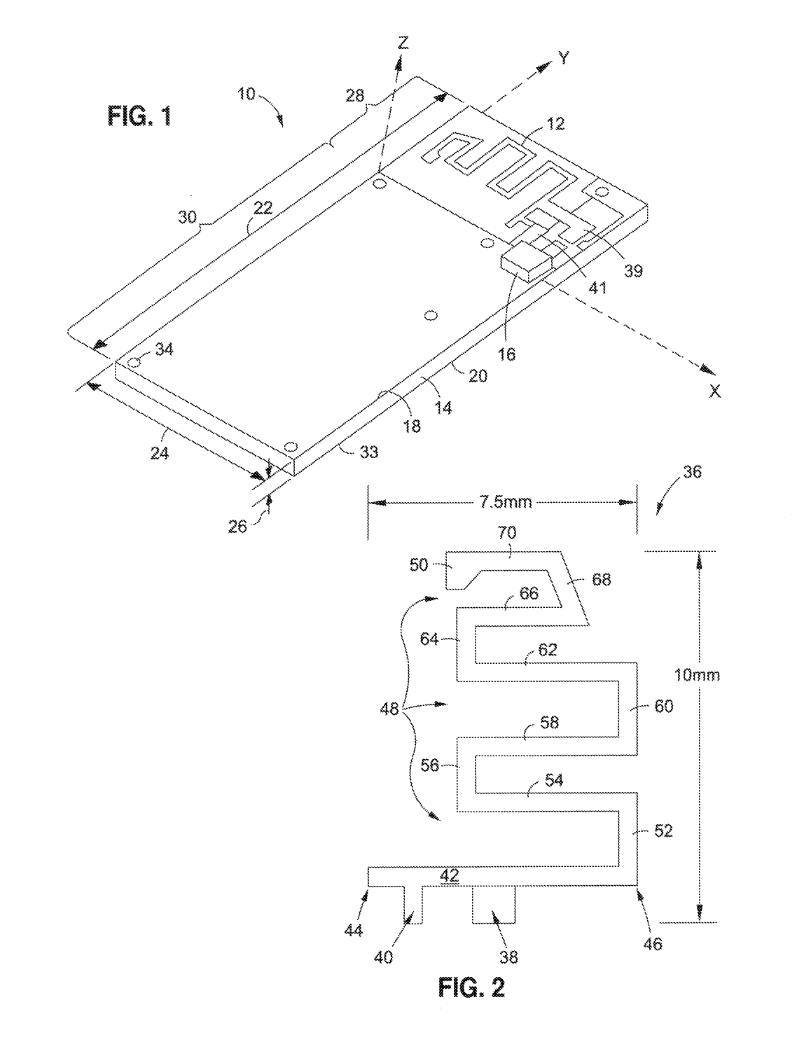

FIG. 1 depicts an antenna assembly 10 with one embodiment of a printed antenna 12. The antenna assembly 10 includes a printed circuit board (PCB) substrate 14, to which the printed antenna 12 is affixed. Mounted to the PCB substrate 14 is a radio frequency (RF) front end integrated circuit 16. Additional electronic components necessary for wireless communications such as transceiver modules and general-purpose data processors may also be mounted to the PCB substrate 14 and electrically interconnected, but these have been omitted. The PCB substrate 14 may thus be that of a communications device such as a smart phone, a wireless networking card, and so forth. In this regard, the communications device, and hence the RF front end integrated circuit 16 is understood to implement WiFi, Bluetooth, and/or ZigBee data communications over the 2.4 GHz Industrial-Scientific-Medical (ISM) band. The presently disclosed antenna assembly 10 and printed antenna 12 need not be limited to such applications and its attendant frequency and bandwidth parameters. As will be discussed in further detail below, the operational parameters may be adjusted to meet the requirements of the intended application.

The PCB substrate 14 has a generally planar, quadrangular configuration with a top surface 18 and an opposed bottom surface 20. In the illustrated exemplary embodiment, the PCB substrate 14 has a length 22 of 40 mm, a width 24 of 15 mm, and a thickness 26 of 1.524 mm. Furthermore, for purposes of the present disclosure in illustrating the performance of the printed antenna 12, the PCB substrate 14 has a lengthwise axis Y, widthwise axis X, and a vertical axis Z. By way of example only the PCB substrate 14 is a conventional glass-reinforced epoxy that is laminated with 1 oz. copper foil, also designated as FR4. As will be recognized, these dimensions and materials parameters such as substrate composition, conductor thickness, and the like may be modified to conform to the structural constraints of the RF communications device in which it is utilized, while still meeting the stated performance objectives of the antenna assembly 10.

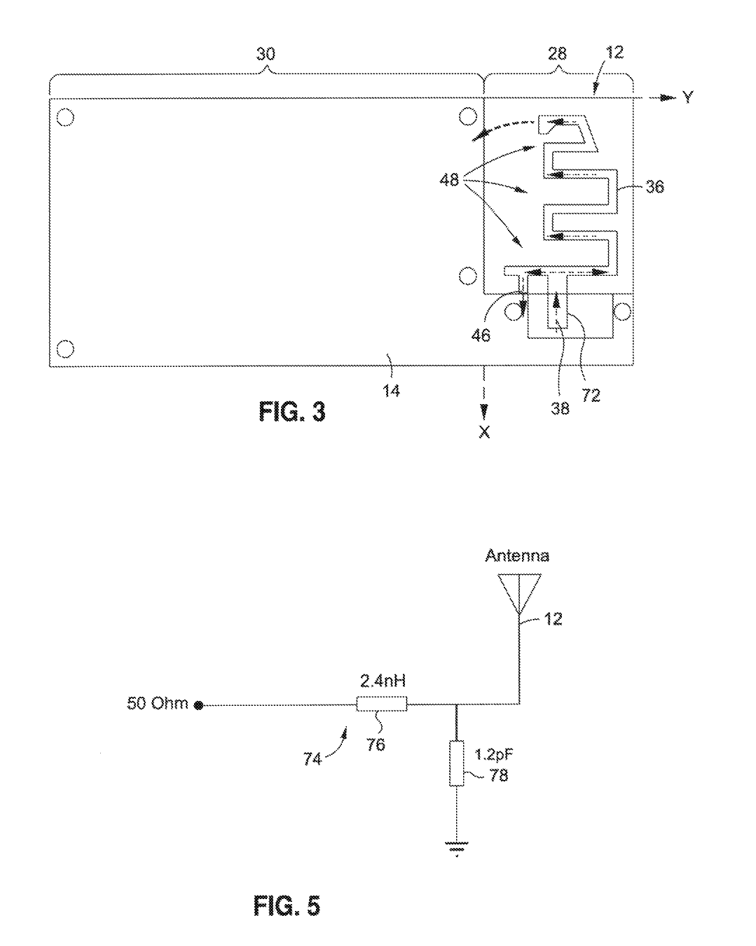

The PCB substrate 14 is generally segregated into a first section 28 and a second section 30. The top surface 18 of the second section 30 includes a ground plane 32 comprised of the copper laminate. In some embodiments, the bottom surface 20 of the second section 30 also includes a separate ground plane 33, which extends into a portion of the first section 28 as best shown in FIG. 3. Accordingly, the second section 30 may refer to a corner section of the PCB substrate. The bottom surface 20 of the first section 28 is contemplated to have no copper laminate affixed thereto. Because of this, the first section 28 may also be referred to as a bare section. It is understood that the ground planes 32, 33 reduces noise and references the various electronic components mounted on the antenna assembly 10 to a common ground. The top surface 18 of the first section 28 is etched and the copper laminate defines the printed antenna 12. Where other electronic components are mounted to the bottom surface 20 of the PCB substrate 14, there are conductive vias 34 that extend between the bottom surface 20 and the top surface 18 and electrically connect the ground or common terminals of such devices to the ground planes 32, 33.

With additional reference to FIG. 2, the printed antenna 12 is generally comprised of an electrically conductive radiating element 36, a feed line 38, and a ground line 40. The feed line 38 also defines a feed port 39 to which the microstrip feed line from the antenna port of the RF front end integrated circuit 16 is connected. The ground line 40 defines a ground port 41. For wireless communication applications in general, the design of an antenna involves several considerations as discussed briefly above. These include small size, high performance (bandwidth, gain/efficiency, return loss, noise figure, resistance to external influences, specific absorption rate (SAR), etc.) and low cost. The features of the radiating element 35 have been contemplated in accordance with such considerations.

The radiating element 36 includes a primary segment 42 is elongate with a left end 44 and an opposed right end 46. The length of the primary segment 42 is understood to be 7.5 mm. The feed line 38 and the ground line 40 are connected to and are structurally contiguous with the primary segment 42 in a perpendicular relationship thereto, and may be referred to as an inverted-F configuration. In further detail, the ground line 40 is positioned toward the left end 44, and the feed line 38 is positioned to the right of the ground line 40 but generally central between the left end 44 and the right end 46. A specific example contemplates that from the left end 44 to the ground line 40, there is a separation distance of approximately 1 mm. The distance between the ground line 40 and the feed line 38 is understood to correspond to the impedance of the radiating element 36, and more particularly that of the high frequency loop formed thereon as will be discussed in further detail below. This, in turn, is understood to improve return loss characteristics of the printed antenna 12. In one exemplary embodiment, the distance is 1.4 mm. The width of the feed line 38 is contemplated to be approximately twice the ground line 40, which is the same as the primary segment 42 as well as the remainder of the radiating element 36. This is understood to ensure a wide antenna bandwidth. The height of the feed line 38 and the ground line 40 is, by way of example, 1 mm.

The radiating element 36 is comprised of a plurality of successive meander segments 48 and ends at a radiating element tip 50. More particularly, these meander segments 48 include a first vertical segment 52 that is perpendicular to the primary segment 42. Opposite the primary segment 42 is a first lateral segment 54, which according to one embodiment, has a length of 4.5 mm. The separation distance between the first lateral segment 54 and the primary segment 42, i.e., the length of the first vertical segment 52, is 1.5 mm. Extending in a perpendicular relationship upwards from the end of the first lateral segment 54 opposite the first vertical segment 52 is a second vertical segment 56. In turn, there is a second lateral segment 58 with an exemplary length of 4.5 mm extending in a perpendicular relationship thereto. The separation distance between the first lateral segment 54 and the second lateral segment 58, i.e., the length of the second vertical segment 56 is 1 mm. Opposite the junction with the second vertical segment 56, a third vertical segment 60 extends from the second lateral segment 58. Furthermore, there is a third lateral segment 62 with an exemplary length of 4.5 mm extending in a perpendicular relationship to the third vertical segment 60. The third lateral segment 62 and the second lateral segment 58 are separated by 1.5 mm. From an end of the third lateral segment 62 opposite the junction with the third vertical segment 60 extends a fourth vertical segment 64. Connected in a perpendicular relation to the fourth vertical segment 64 is a fourth lateral segment 66, which is separated from the third lateral segment 62 by a distance of 1 mm. There is an angled segment 68 extending at an oblique angle from the fourth lateral segment 66, from which a fifth lateral segment 70 extends in a parallel relationship thereto.

Each of the first lateral segment 54, second lateral segment 58, third lateral segment 62, fourth lateral segment 66 and fifth lateral segment 70 are in a parallel relationship to each other. Similarly, the second vertical segment 56 and the fourth vertical segment 64 are coaxial, and the first vertical segment 52 and the third vertical segment 60 are as well. The second vertical segment 56 and the fourth vertical segment 64 are parallel to the first vertical segment 52 and the third vertical segment 60. The total height combining each of the vertical segments is, by way of example, 10 mm.

As best illustrated in FIG. 3, the meander configuration of the radiating element 36 causes the formation of a high frequency current loop 72 with an origin at the feed line 38, and a terminus of the ground plane section 30. More particularly, one terminus is understood to be the ground line 40, which is electrically connected to the ground plane section 30. In this regard, the ground line 40 is positioned so that it corresponds to the terminus of the high frequency current loop 72.

The high frequency current loop 72 also extends through the meander segment 48 to the radiating element tip 50. With a gap defined by the bare or first section 28 of the PCB substrate 14, the high frequency current loop 72 terminates at the ground plane section 30. The radiating element tip 50 is understood to have a flared end with a width of 1 mm, though the fifth lateral segment 70 to which it is connected has a width of 0.5 mm as the remainder of the radiating element 36. The distance between the radiating element tip 50 and the ground plane or second section 30 of the PCB substrate 14 corresponds to the degree of coupling, and can be optimized for maximum bandwidth and minimum return loss.

The high frequency current loop 72 is understood to confine the current and the electromagnetic fields on the printed antenna 12, as will be demonstrated below. The operational principles thereof are detailed in U.S. patent application Ser. No. 12/914,922 entitled “FIELD-CONFINED WIDEBAND ANTENNA FOR RADIO FREQUENCY FRONT END INTEGRATED CIRCUITS,” the disclosure of which is wholly incorporated by reference in its entirety herein. By thus confining the current and electromagnetic fields, coupling between the printed antenna 12 and the surrounding circuit components are understood to be reduced. As a secondary benefit, the overall dimensions of the printed antenna 12 may be reduced.

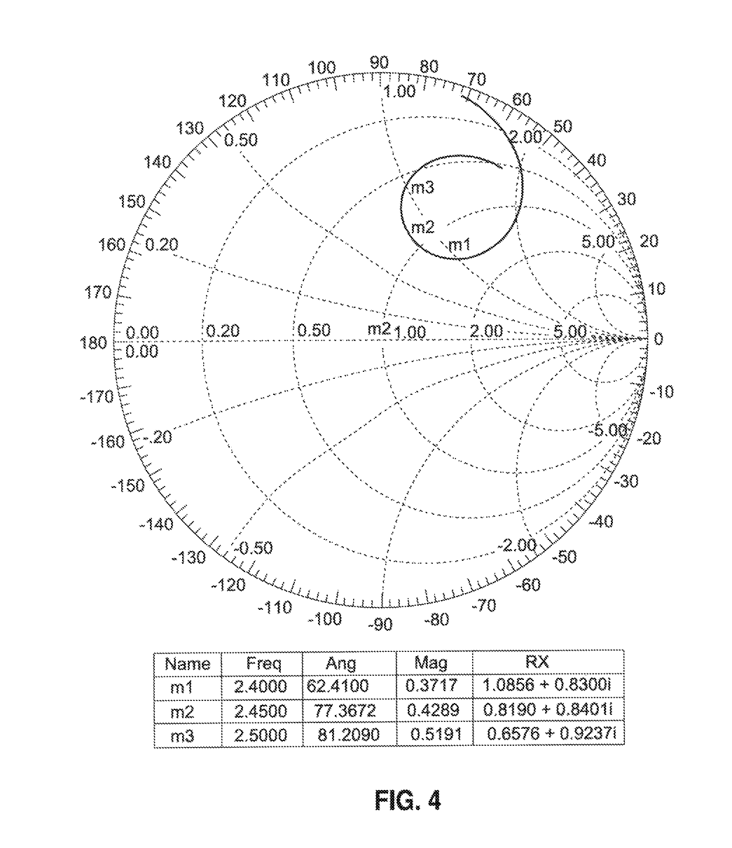

The performance of the printed antenna 12 has been simulated, and the Smith chart of FIG. 4 shows the resultant return loss without a matching circuit. As indicated by the Smith chart, the printed antenna 12 exhibits wideband performance and can be readily matched to a 50 Ohm impedance of the antenna port on the RF front end integrated circuit 16.

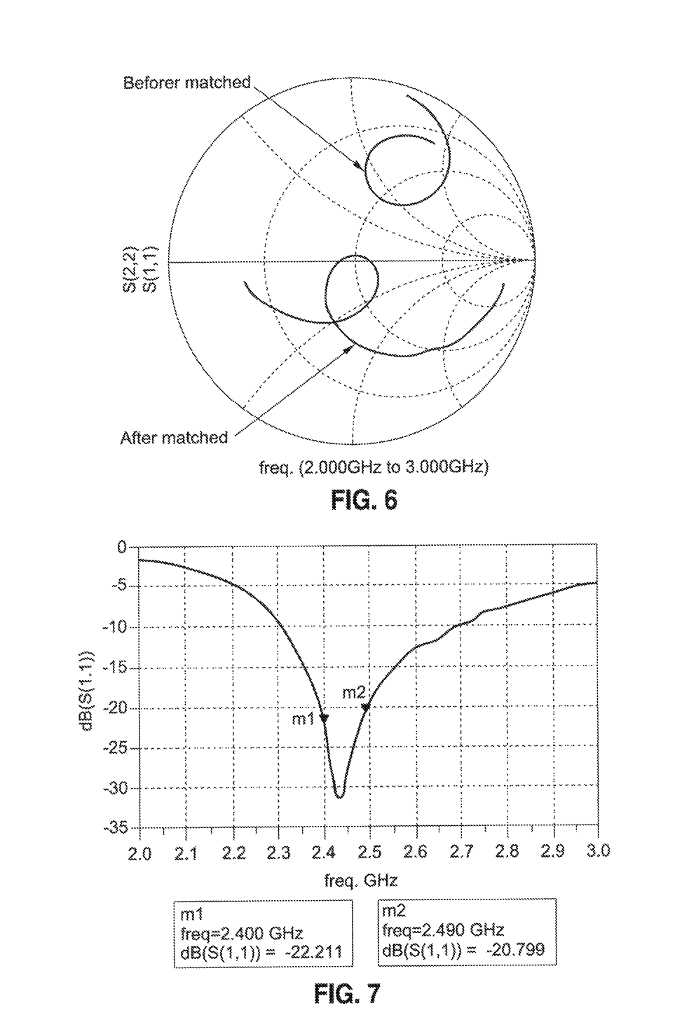

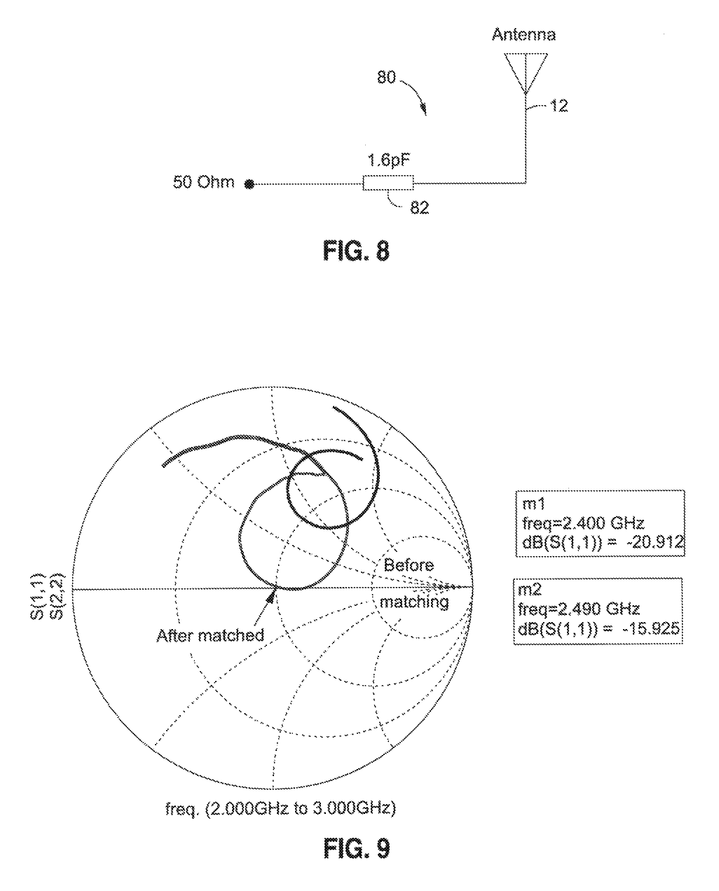

FIG. 5 illustrates one exemplary two-element matching circuit 74 with an inductor 76 of 2.4 nH connected to the microstrip line from the RF front end integrated circuit 16. There is also a capacitor 78 of 1.2 pF that is connected to the inductor 76 and the printed antenna 12. The Smith chart of FIG. 6 reproduces the simulated return loss of the printed antenna 12 without the two-element matching circuit 74, and shows the simulated return loss with the two-element matching circuit 74. As shown in the graph of FIG. 7, the return loss across the operating frequency band of 2.4 GHz to 2.49 GHz is better than −20.8 dB. Furthermore, bandwidth were the return loss (S11) is −10 dB is approximately 390 MHz.

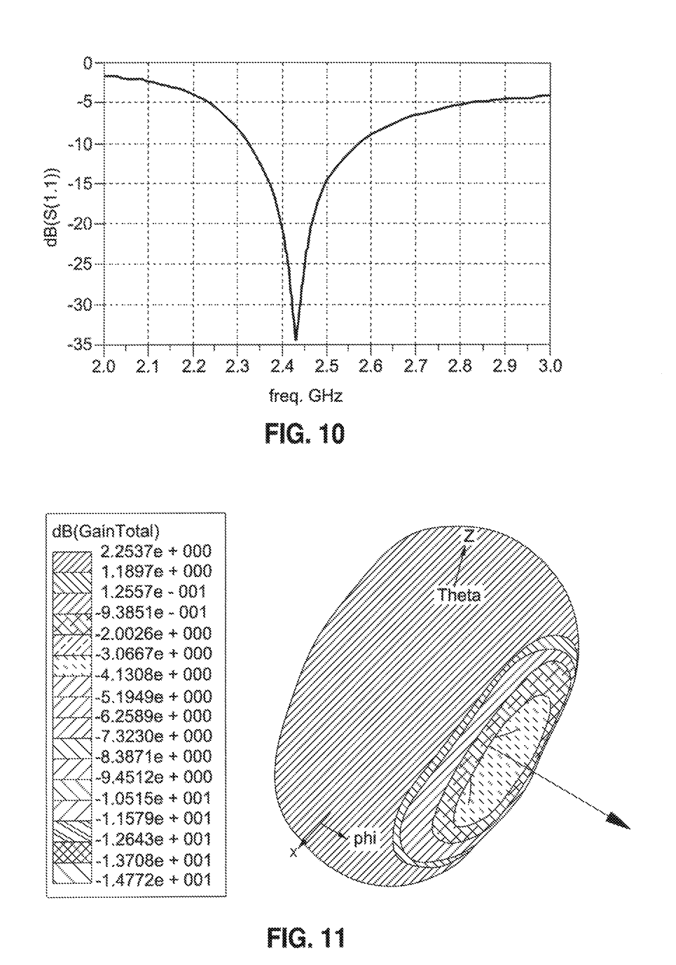

Another embodiment contemplates a single element matching circuit 80 with a capacitor 82 with a value of 1.6 pF that is connected to the microstrip line from the RF front end integrated circuit 16 and the printed antenna 12. The Smith chart of FIG. 9 again reproduces the simulated return loss of the printed antenna 12 without any matching circuit, and shows the simulated return loss with the one-element matching circuit 80. The graph of FIG. 10 further illustrates that the return loss across the operating frequency band of 2.4 GHz to 2.49 GHz is better than −15.98 dB.

FIG. 11 shows a three-dimensional representation of the radiation pattern of the printed antenna 12. More specifically, the radiation pattern in the X-Z plane is substantially omni-directional. In the Y-direction, which is understood to correspond to the axis along which the RF front end integrated circuit 16 as well as any other electronic components are disposed, the radiation field is weak and therefore less coupling. According to the HFSS simulation results, the peak gain at 2.45 GHz is 2.25 dBi, with a radiation efficiency of 95.19%.

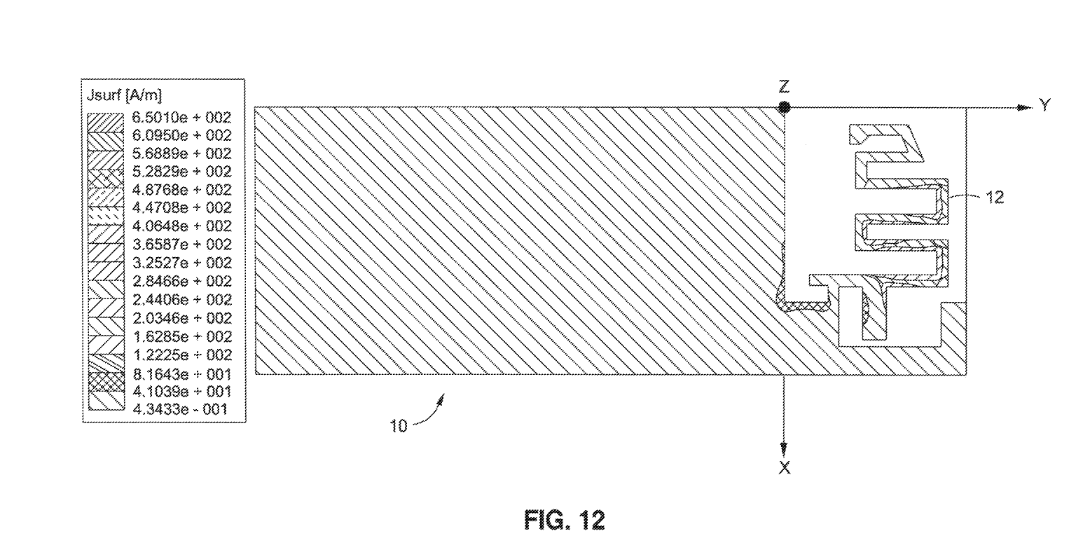

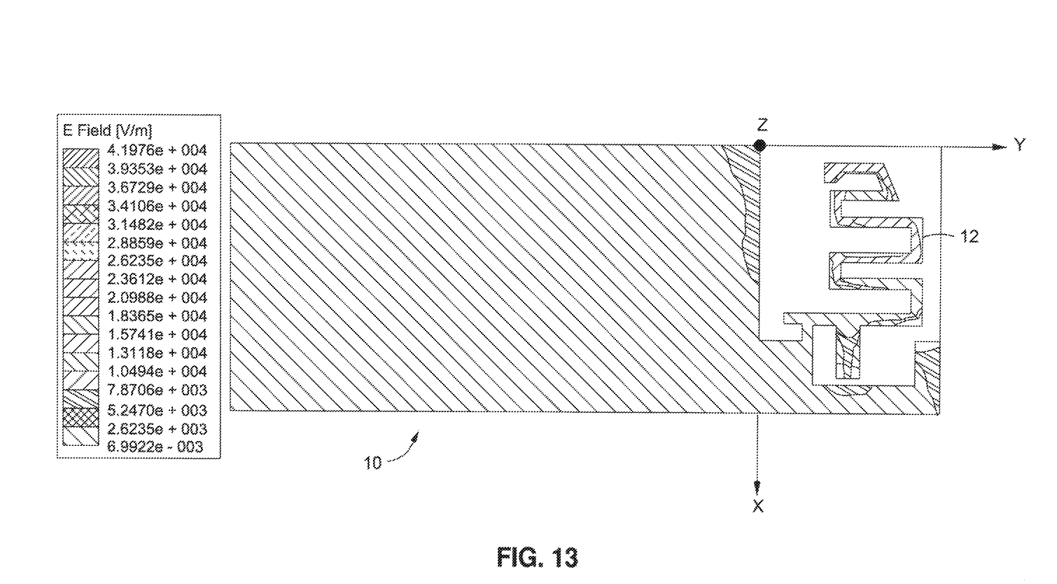

In FIG. 11 and FIG. 12, there is illustrated a simulated current and electric field distribution, respectively, on the surface of the printed antenna 12 and the antenna assembly 10. As indicated above, the current and electric fields are confined in the printed antenna 12 in part due to the high frequency current loop 72, resulting in reduced coupling with nearby components.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention with more particularity than is necessary for the fundamental understanding of the present invention, the description taken with the drawings making apparent to those skilled in the art how the several forms of the present invention may be embodied in practice.

What is claimed is:

1. A printed circuit board (PCB)-printed antenna for a radio frequency (RF) front end integrated circuit with an antenna port and having a predetermined operating frequency band, the PCB-printed antenna comprising:
a printed circuit board substrate having a conductive ground plane and a bare section;
a ground line connected to the conductive ground plane section and defining a ground port;
a feed line defining a feed port connectible to the antenna port of the RF front end integrated circuit;
an electrically conductive radiating element fixed to the bare section of the printed circuit board substrate, the radiating element being in an inverted-F configuration with a primary segment thereof extending in a perpendicular relationship to the connected ground line and the feed line, the radiating element further including a plurality of successive meander segments initially connected to the primary segment and ending at a radiating element tip;
wherein a high frequency current loop is formed with an origin from the feed line to a terminus on the ground plane on the printed circuit board substrate via the ground line and the radiating element tip, the high frequency current loop confining current and electronic fields on the radiating element.

2. The PCB-printed antenna of claim 1, wherein the ground line is connected to the radiating element at a position corresponding to the terminus of the high frequency current loop.

3. The PCB-printed antenna of claim 1, wherein a width of the feed line is approximately double a width of the ground line.

4. The PCB-printed antenna of claim 1, wherein a width of the radiating element is substantially equivalent to a width of the ground line.

5. The PCB-printed antenna of claim 1, wherein a distance between the feed line and the ground line defines an impedance of the radiating element.

6. The PCB-printed antenna of claim 1, wherein a distance between the radiating element tip and the conductive ground plane corresponds to the amount of coupling between the radiating element and the printed circuit board substrate.

7. The PCB-printed antenna of claim 1, wherein the ground line and the feed line are structurally contiguous with the radiating element.

8. The PCB-printed antenna of claim 1, wherein the RF front end integrated circuit is mounted on the printed circuit board substrate.

9. The PCB-printed antenna of claim 8, wherein the antenna port of the RF front end integrated circuit is electrically connected to the feed port over a microstrip line.

10. The PCB-printed antenna of claim 9, further comprising:
a matching circuit interconnecting the feed line and the antenna port of the RF front end integrated circuit, the matching circuit impedance matching the antenna port to the radiating element.

11. The PCB-printed antenna of claim 10, wherein the impedance of the RF front end circuit at the antenna port is 50 Ohms.

12. The PCB-printed antenna of claim 10, wherein the matching circuit has a two-element configuration including a capacitor and an inductor.

13. The PCB-printed antenna of claim 10, wherein the matching circuit has a one-element configuration with a single capacitor.

14. The PCB-printed antenna of claim 1, wherein the printed circuit board substrate conforms to the National Electrical Manufacturers Association (NEMA) FR-4 glass reinforced epoxy laminate specification having a 60 mil thickness.
